(19) United States
(12) Patent Application Publication
(10) Pub. No.: US 2013/0282524 A1
(43) Pub. Date: Oct. 24, 2013

(54) SYSTEMS AND METHODS FOR PROVIDING REAL ESTATE SERVICES

(71) Applicant: Applied Real Technologies LLC, Austin, TX (US)

(72) Inventors: Brett Appolito, Austin, TX (US); Aaron Jistel, Cedar Park, TX (US)

(21) Appl. No.: 13/783,389

(22) Filed: Mar. 3, 2013

Related U.S. Application Data
(60) Provisional application No. 61/606,401, filed on Mar. 3, 2012.

(51) Int. Cl. G06Q 30/06; G06Q 50/16

(52) U.S. Cl. CPC G06Q 30/0613; G06Q 50/16
USPC 705/26.41

(57) ABSTRACT

Real estate brokerage systems and methods are provided. A user may sign up for a real estate brokerage service via a system, such as a website or other network accessible software program. A real estate brokerage system may aggregate information from multiple computer-based real estate information systems, such as an MLS, governmental offices, title companies, credit rating companies, etc. The real estate brokerage system can provide a graphical user interface (GUI) to allow users to access the system and services. The systems and services may be provided for a periodic rate, such as a daily rate, that is independent of the value or selling amount of a listed property. There can also be add-on services, such as photography or staging, for additional amounts, which might be recurring or a one-time charge.

### CROSS REFERENCE TO RELATED APPLICATIONS

The present application is a continuation of and claims priority to pending Provisional Patent Application No. 61/606,401, entitled Systems and Methods for Providing Real Estate Services, filed on Mar. 3, 2012, the contents of which is hereby incorporated by reference in its entirety.

### BACKGROUND

In the real estate industry, licensed real estate brokers are generally paid on a commission basis for the buying and selling of real estate. The “industry standard” for a real estate commission is 6%. From this commission, a broker representing the buyer in the transaction is generally paid an industry standard of 3%. Thus the broker enlisted by the seller is paid a 3% commission (or the entire 6% commission if no broker is enlisted by the buyer, or the selling broker acts in an intermediary status). Generally the amount of work, time, and money spent by the seller broker (also called the “listing broker”) on the marketing and selling of the property is at the discretion of the selling broker. Conversely, the property owner has sole discretion over the acceptance of any contracts that transfer the possession of said property. However, the property owner is usually advised by their selling broker for matters pertaining to the specific sale of their property. In this model the listing broker derives their professional value from their access to information (for example, through the local Multiple Listing Service or “MLS”), their ability to market a property, and their experience in in the real estate industry.

There are problems with this arrangement. For one, it generally costs a seller a large amount of money in commissions to market and sell their property, even if the property sells quickly.

Second, a conflict often arises between the selling broker and the property owner. The property owner can feel that the selling broker is not doing the necessary amount of work to market and sell their property. The selling broker can feel that the property owner is being unreasonable and difficult about the terms by which the property is being sold. A drop in the list price or final sale price might speed up the transaction process enabling the selling broker to get paid more quickly. This might only cost the selling broker a few hundred dollars in commissions, but can cost the owner several thousand dollars, which can be a very large portion of their equity if they have a mortgage. Conversely, the selling broker can become frustrated when the property owner refuses to heed the broker's advice regarding the marketing and selling of the property. This can lead to what the broker feels is a prolonged listing period. In addition, the property may not sell at all. In this case, the listing broker may not receive any commission and has lost time and money on their marketing efforts.

A third problem is that technology has significantly decreased the amount of “man hours” that are required of a real estate broker. Yet, the pay structure for a real estate broker continues to be based on a model developed decades ago. Real estate brokers are able to leverage their access to information, specifically access to the MLS, into highly inflated commissions.

Therefore, systems and methods are needed for providing improved real estate services.

### BRIEF DESCRIPTION OF THE DRAWINGS

FIG. 1 is a diagram of an illustrative embodiment of a system for providing real estate services;

FIG. 2 is a diagram of another illustrative embodiment of a system for providing real estate services;

FIG. 3 is a flowchart of an illustrative embodiment of a method of providing real estate services; and

FIG. 4 is a flowchart of another illustrative embodiment of a method of providing real estate services.

### DETAILED DESCRIPTION

In the following detailed description of the embodiments, reference is made to the accompanying drawings which form a part hereof, and in which are shown by way of illustration of specific embodiments. It is to be understood that other embodiments may be utilized and structural changes may be made without departing from the scope of the present disclosure.

The systems and methods described herein can provide services and products to property buyers and sellers through a network-based system interface. Although the terms buyers, sellers, etc. are used herein, the service can provide for rentals or leases as well as property sales. The system can also connect property owners, title companies, third party vendors, buyers and buyers' representatives, and real estate brokers for communication or document exchange through the interface. The user can be charged for the real estate services, products and system use over a recurring time period.

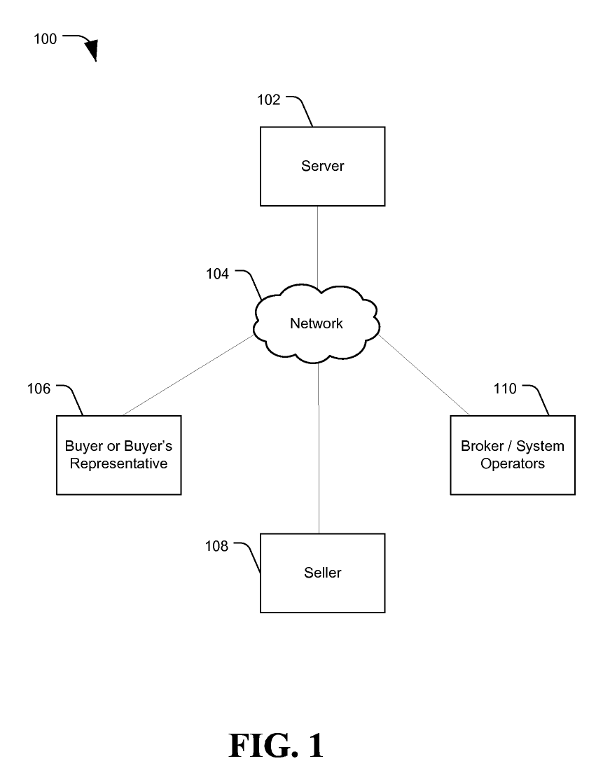

FIG. 1 depicts a diagram of an illustrative embodiment of a system for providing real estate services, generally designated 100. The system may include a computer server 102 and software application(s) running on the server. The software may be executed by a processor to provide a user interface or other data over a network 104. The network 104 may be an internet, intranet, the world wide web, or other kind of network, and it can be wired or wireless. The server 102 or other servers coupled thereto may include data storage capabilities for the user, user accounts, and related services. Further, the server 102 can have a network interface to communicate with other real estate services either directly or through a data communication protocol, which can be the network 104 or through another connection.

The system 100 may also include nodes through with end users can access the server 102 or network 104. For example, the system 100 may include software or applications running on devices for a buyer or buyer's representative 106, for a property seller 108, and for a broker, system operators, or third party vendors 110. End user devices 106-110 may include personal computers, tablets, smart phones, or box-top sets, gaming consoles, televisions, or other devices with network connectivity. In some embodiments, end users access the system 100 via a web browser accessing a website running on the server 102 through an internet network 104. Services and functions of the system 100 may be displayed on the end users' web browsers with no special software running on an end user machine. In other embodiments, end users may install programs or applications on their devices allowing for connection to the service 106 through a private network 106, or to provide system functionality to the end users. For example, a property seller may download a mobile application which notifies the seller when a property offer has been made, or allows the seller to access system databases on the phone. In another example, a user may install a program on a personal computer to access system resources without using an internet browser.

In some embodiments, the system 100 can be membership-based, and users can sign up for the system 100. This system can be computer hardware and software technology-based and provide an internet-based user interface that enables the property owners or buyers to receive information, make decisions, and carry out actions on their own terms. The system 100 will allow users to manage a process flow for selling or buying real estate and similar services. Access to the tools and services may be available to users via a graphical user interface (GUI), which may be implemented via any combination of local computing devices 106-110 and servers 102 connected to one or more networks 104.

Physical products such as “for sale” signs and lock boxes can be delivered to a property owner via mail or courier. Intangible services and products, such as consultations, can be managed through the user interface; such as via a voice over internet protocol (VOIP) service, chat service, instant message (IM) service, other computer based communication technology, telephone calls, or scheduling of in-person meetings.

Service appointments such as photographers and home stagers can be scheduled through the user interface. Information transfers such as changes to a listing can be carried out through a document sharing aspect of the user interface, or by editing information stored on the server 102 or shared online with databases. Marketing services such as fliers and open houses can be designed, reviewed, approved, and managed through the user interface. Real estate information such as market statistics can be provided through the user interface. Contract negotiations can be handled through the user interface by allowing document sharing, editing, conference calls, multiple computer viewing the document at once, etc. The system can be configured with limitations on contracts or procedures, such as according to state laws or real estate governing bodies. Payment for the services can be charged to the user via a credit or debit card held on file, paid via check, money order or transfer, or by other methods. Additional charges may be paid via credit or debit card or may be handled through the title company at closing.

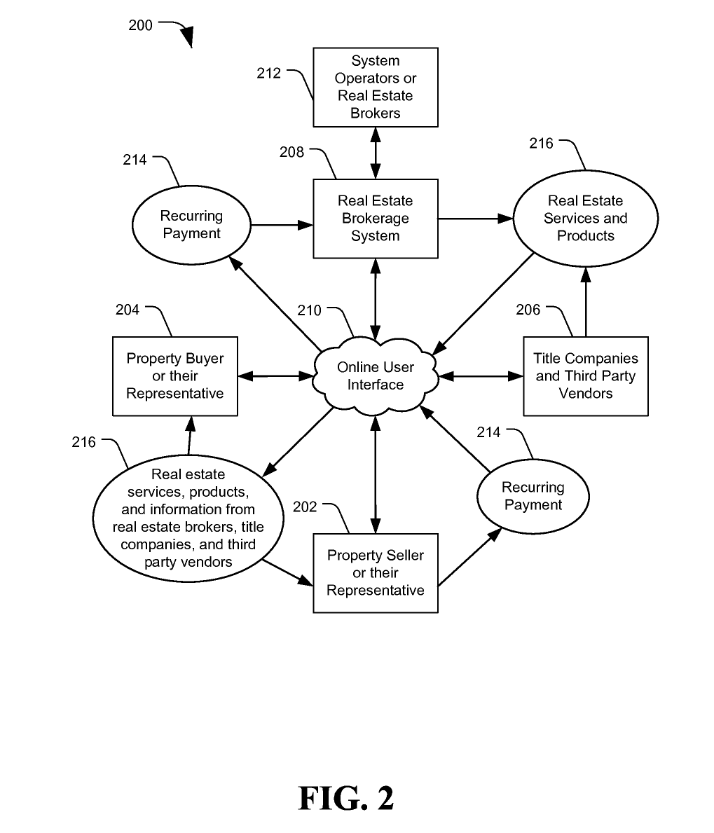

FIG. 2 depicts a diagram of another illustrative embodiment of a system for providing real estate services, generally designated 200. In the depicted embodiment, a property seller 202, property buyer 204, and title companies or third party vendors 206 can connect to the real estate brokerage system 208 through an online user interface 210, such as a dedicated website. The real estate brokerage system 208 may be maintained, updated, or monitored by system operators 212.

The user interface 210 can act as the main method of information exchange between the seller 202, buyer 204, various 3rd parties 206, and the system operators 212. The interface 210 allows system managers 212 to post pertinent data, information and messages regarding the listings and accounts to the users. In addition, the system facilitates the contact and exchange of information, documentation and products between the users, system operators and various 3rd parties. Said 3rd parties 206 can include, but aren't limited to, title companies, lenders, contractors, appraisers, inspectors, and marketing and advertising providers. Users are notified via text message, email, or visual display on the interface 210 when recent activity regarding their listing or account takes place. For example, a prospective buyer may flag a property listing so that the buyer is notified if the listed price changes.

Different users may have different types or levels of membership or access to the brokerage system 208. For example, a property seller may have one type of membership, with access to real estate selling services, while a buyer may have a different type of membership allowing the buyer to search for available properties and submit offer contracts or proposals. Meanwhile, title companies and third party vendors may have a third type of access allowing them to offer services or upload tutorials, written guides, or other products 216 for buyers or sellers. Users can utilize a member home page to manage their listings and account. The home page can show their listings, recent listing activity, recent account activity, a message board for user-manager communications, or links to other resources to manage their accounts and listings.

Some examples of information and services available to users through the user interface 210 can include, without limitation:

Account Information: Users have access to vital information such as billing and contact information. Users can edit such information as well as view billing activity.

Photography: Professional photography data is available via the online user interface 210. This data can be uploaded directly by the photographer or system operators 212. The data can be processed as pictures, videos, “virtual tours” or other photographic marketing materials. Users can also upload their own pictures. The user may have the ability to edit or arrange the pictures, select certain pictures for use in the MLS and online marketing websites, or use the pictures for other marketing materials.

Resources: Users can have access to a variety of non-human resources that may include, but are not limited to home selling guides, staging advice, or other real estate advice. Additionally, users can be provided resources to help them best utilize the system. These resources may come in the form of videos, audio tracks, interactive walkthroughs, and literature or internet links. The resources may be imbedded in the interface 210 available for download or hosted by a third party. The service may aggregate information from multiple computer-based real estate information providing systems and allow users to browse information from individual sources, or combine information into a single database for users to review.

Showings and Feedback: The system 208 can utilize electronic lockboxes issued by the local real estate boards. The lockboxes can allow access to licensed agents for showings and other authorized third parties. Showings and showing feedbacks can be entered into the system 208 for users to view. When a showing or feedback is entered in the system 208, the user can receive a text message or email with the showing data.

Real Estate and Marketing Services and Products: Users have the ability to choose from a variety of a-la-carte real estate and marketing services and products 216 through the user interface 210. These services and products 216 may be part of the recurring payment structure or purchased for additional charges. These charges may be charged to the user's payment method on file. The services and products 216 include, but are not limited to: yard signs, yard sign upgrades, real estate flyer templates, real estate flyers, photography packages, real estate marketing post cards, in house marketing binders, staging services, open house packages, email marketing campaigns, flyer boxes, contract consultations, contract coordinators, marketing consultations and courier services. Tangible items can be selected, managed and paid for (if necessary) through the interface 210 and shipped to the user. Non-tangible items, such as consultations, can be selected, arranged and paid for (if necessary) through the interface 210. The method of delivery of such non-tangible items include, but are not limited to: phone communications, online chat communications, email, video conferencing, webinars, personal interactions, or any combination of the previously listed.

Property sellers, buyers, and third party vendors may have different payment requirements. For example, sellers may have to pay a daily, weekly, monthly, or use-based recurring fee 214; buyers may sign up for free access to encourage sales; and title companies and third party vendors may have to pay a percentage of sales to have their services or products offered through the brokerage system (not shown). Services, products, payments, contracts, and other information may be exchanged between buyers 204, sellers 202, the brokerage system 208, etc. via the user interface 210.

System operators and brokers 212 can use the real estate brokerage system 208 to upload data to or retrieve data from the online user interface 210. For example, the real estate system 208 could use the user interface 210 to upload a listing agreement for a title company representative; transmit a contract from a seller 202 to a buyer 204 by sharing the document through a secure website; or to provide third parties with access to vital property information. Similarly, the real estate system 208 could use the user interface 210 to receive messages that a new contract has been uploaded for one of the listed properties; access information on a property that is stored in the user interface; receive a notification that one of the sellers 202 is in need of assistance; or download pictures to place in the MLS that a photographer has uploaded to the user interface.

Sellers 202 can upload data to or retrieve data from the online user interface 210. For example, sellers 202 could use the user interface 210 to submit information on his or her property by uploading the data to a user interface website; schedule a photographer session; or upload a counter proposal or contract to a prospective buyer 204. Sellers 202 can also use the user interface 210 to receive a notification that a buyer 204 has submitted a contract on the seller's property; access submitted contracts; or access information and products offered through the user interface 210, such as tutorials on selling property, sample contract forms, or listings of what prices other properties are being offered or sold.

Title companies and third party vendors 206, such as contractors, home stagers, or photographers, can also upload data to or retrieve data from the online user interface 210. For example, the title companies or third party vendors 206 could use the user interface 210 to upload or send a title commitment to a buyer 204; schedule a closing or other appointment; request additional documentation from a seller 202, a buyer 204, or a real estate broker 212; or upload pictures for a property. Title companies and third party vendors 206 can also receive information via the user interface 201, such as notifications of service requests, or access to contracts or other documents.

Similarly, buyers or buyer's representatives 204 can also upload data to or retrieve data from the online user interface 210. For example, buyers 204 could use the user interface 210 to submit a contract to a property owner, or schedule a showing on for a property listed with the real estate brokerage system 208. Likewise, a buyer 204 can use the interface 210 to access information about a property, receive a counter-offer from a seller 202, access a title commitment from a title company, access documentation from a listing broker, or browse available properties from a database.

Real estate brokers 212, title companies and third party vendors 206 can also provide real estate services, products, and information 216 through the user interface 210 or based on interactions on the interface. These products and services can include both digital data as well as physical items. Some examples include a system operator or broker 212 sending out a “for sale” sign, listing lockbox, or listing flyers to a seller 202 that signed up for the service or purchased the items through the user interface 210; a broker 212 or third party vendor 206 may provide a consultation to a property owner 202 via a webinar or conference call through the interface 210; the user interface 210 may provide market data and listings; sellers 202 may schedule a home stager; a seller 202 may add their property to the MLS; or a seller 202 may access real estate contracts and addenda through the interface 210.

Recurring payment 214 can represent the fee a system user must pay to access the real estate brokerage system 208. In FIG. 2, only the seller 202 is show making the payment 214, but in some embodiments buyers 204 or title companies or third parties 206 may also be required to make payments to utilize the brokerage system 208. In an example embodiment of the payment system, a property owner 202 may upload a credit or debit card to the user interface 210 when signing up for the system 200. The user interface 210 may automatically charge the property owner 202 the first day of each new month for the total number of days the property owner used the system the previous month. For example, on Mar. 1, 2013 the user interface may charge the user $4.99 a day for 28 days system usage in Feb. 2013 totaling $139.72. The property owner 202 may not be charged for days the system was not “used,” where use can be variably defined to include listing a property, accessing other features of the system, or another payment structure. The interface may charge the property owner's card on file and deposit it with the real estate brokerage. In some embodiments, the property owner 202 can opt to pay a flat monthly fee on a recurring basis, or the user's card could be charged once a day for use. Other embodiments are also possible.

In an example embodiment, the system can provide the services and products to a property owner through an internet based user interface for a daily rate or a monthly rate. The rates may be flat rates per period per each listing on the service.

In another example embodiment, the system can provide a “base level” of tools and services (such as, including a listing on the MLS) through the user interface on a per diem rate. Any additional tools or services not included in the “base level” can be provided to the property owner as requested. For example, multiple variations can be included. In one variation, the costs of the additional tools and services can be assessed upfront at the point of sale. For example, the user could select add-on services on an as-needed basis and pay for them at the time of selecting them. The add-ons could be one-time fees or could be added to a total of recurring charges. In another variation, the costs of the additional tools and services can be assessed retroactively once the property owner closes the account or at some other specified time. In yet another variation, the costs of the additional tools and services can be charged as an increase to the base level rate. For example, the user could select add-on services at the time of signing up for the service, which could increase the recurring fee rate.

In yet another example embodiment, the system provides a “base level” of the tools and services as described above, but with a monthly rate instead of a per diem rate. Any additional tools or services not included in the “base level” can be provided to the property owner as requested and as described above.

According to the described system, a property owner, buyer, etc. can create a password protected account through the user interface and then becomes a system user. This can include entering contact information and payment information. Payment type may consist of any type of electronic or non-electronic transfer of funds, such as credit card, debit card, EFT, direct transfers, Paypal, pre-paid gift cards, checks, or any other payment means.

Once the user has an active account in the system, they can be provided with the available real estate services, products, and information through the user interface. For example, the products and services available to a seller may include those generally associated with licensed real estate broker and a full-service MLS listing. The services, products, and information may include, but are not limited to the following: access to real estate related contracts and documents; access to market data provided by local Realtor boards; electronic lock boxes as issued by local realtor boards; yard signage; the ability to list properties in the MLS; professional photography; marketing flyers; direct mail marketing; email marketing; open house packages; professional staging services; real estate agent and broker property tours; property showings and showing feedback; marketing packets or binders; combination lock boxes; professional consulting and advice from licensed real estate broker or agents; and access to preferred real estate vendors.

The services, products and information can be managed and processed through the user interface. System operators may communicate via phone, SMS messages, email, message boards, on-line chat platforms, webinars, video conferencing, or other media with the user to assist with and facilitate any of the services provided by the system or offer technical support. Methods of delivery for different services and products may differ based on the type of service or product, as described below.

In one example, the user can provide property information through a network via the user interface. The information can be stored for the user to edit at their discretion. System operators can use this information to enter the property in the MLS by way of the appropriate local realtor board.

Tangible services and products that are placed at the property for sale, such as lockboxes, yard signs, flyers, flyers boxes, and other marketing materials can be delivered directly to the property or user. The user may be mailed a lockbox associated with a local realtor board to allow showings and access by licensed agents and other authorized third parties. The user can be instructed on proper use for the lockbox by system tutorials offered on the user interface or by written instructions accompanying the lockbox. In another embodiment, a system operator, employee, or independent contractor may deliver and install a lockbox to the user's property. For example, the user may be mailed a “for sale” sign with instructions and advice on proper use, or a system operator, employee, or independent contractor can deliver and install a “for sale” sign directly to the user's property.

Professional marketing and real estate services that require on-site or in person presence can be arranged, scheduled, and managed through the user interface. For example, the user can schedule a professional photographer through the interface. The system may schedule a professional photographer and the professional photographer can upload and store pictures to the system. Those pictures then can be used in variety of ways to market the user's property. Similarly, the user can schedule a home stager through the user interface.

Real Estate related documentation such as disclosures, agreements, and contracts can be delivered to the user via the online user interface. The system may also send such documents via email, fax, or arrange for such to be hand delivered. For example, a user can download a contract amendment promulgated by a national or state real estate association for use in contract negotiations. In another embodiment, the user may request a contract amendment promulgated by a national or state real estate association to be emailed to them for use in a contract negotiation.

Proposed contracts for the user's property can be submitted by a buyer or buyer's representative through the user interface. From there, the contract can be available for the seller to view and make decisions. The seller can submit any accepted contracts or counter offers to the buyer via the user interface. For example, proposed contracts for the seller's property can be submitted by a buyer or buyer's representative to the system. The system can present the contract to the seller via an online user interface. The seller may submit an accepted contract or counter offer to the system via the user interface. The system may deliver the accepted offer or counter offer to the buyer or buyer's representative.

Real Estate information such as market data and statistics can be delivered to the user via the user interface. For example, the system can provide the user with market data compiled by local realtor boards and the MLS. The user interface can allow the user to search, save and analyze the data so they can make informed decisions on a property. Information and reports pertaining to a seller's listing such as showing reports, showing feedback, agent feedback, contracts on the property, title company documents can be delivered to the user via the user interface. The information and reports may also be customizable. For example, when a licensed agent uses a local realtor board's lockbox to access and show the user's property, the system can alert the user of each access via a visual display on the user interface. In addition, the system can submit a request for showing feedback to the agent that showed the user's property. The feedback received from that agent can also be available for the user via the user interface.

Professional real estate advice and consultations can be conducted via phone, video conference, on-line chat platforms, message boards, video walk-throughs, “webinars” or in person. For example, the user seeks professional advice from a licensed real estate agent in regards to a contract submitted on their property. The user can schedule a phone conference or other meetings through the user interface. For example, a seller seeks professional advice from a licensed real estate agent in regards to a contract submitted on their property. The seller can attend a weekly webinar on “contracts” offered through the system, which may be a webinar or conference call. In another embodiment, the user can schedule an in person meeting, teleconference, video conference or other communication means through the system to receive assistance.

The system may provide additional delivery methods for any or all of the services, products, or information that are provided to the user. For example, a system operator may mail the user a hard copy of an executed contract.

The services, products and information provided by the system and brokerage can be paid for by the user on a rate pertaining to specific periods of time. Such charges may be recurring in nature and can be independent of factors other than the agreement between the system operators and the user for the user to subscribe to the services. Ultimately, the user can pay for a subscription or license to use the system's services. This allows users to utilize all of the professional real estate brokerage tools and to make decisions on the marketing and sale of their property at their own discretion. A user's decisions and the system's operation may be restricted and limited by various laws and governing bodies, but still allows a user to control the marketing and sale of the user's property.

The user can agree to a method of payment and payment incurrences at the beginning of the subscription. A user may be able to change their payment arrangement at a later time.

In an example embodiment, the user registers via the user interface. The user can submit a credit card. In one example, the user can be billed at a selected rate per day until the user cancels the service or a real estate transaction is complete. The charges for the accrued days may be billed on a regular basis, such as monthly. The user can take advantages of the services provided by the system and can agree to a contract on the sale of the user's property. If, for example, a sale concludes 75 days after the user signed up for the services and if the daily rate was $4.99/day, the user would owe a total of $374.25 (plus tax if applicable). If a sale concludes only 7 days after the user signed up for the services, and the daily rate was $4.99/day, the user would owe a total of $34.93 (plus tax if applicable). Either a de-listing by the user, a sale of the listed property is completed, or another event occurring can be used to determine when the period for billing may end.

On another example embodiment, the user registers via the user interface to be billed at a rate of $4.99(plus tax) per day until the user cancels his service. The user is sent a bill every 10 days for the accrued days of service. On the tenth day of service, the user pays $49.90 (plus tax) with a credit or debit card via the user interface. On the 13th day of service, the user decides to cancel the service. The user would owe 3 days of fees (3×$4.99) for $14.97 (plus tax), which could be paid by credit or debit card, or a pay-pal account that could be accessed via the user interface for the unpaid balance for the 3 accrued days of service after the 10th day.

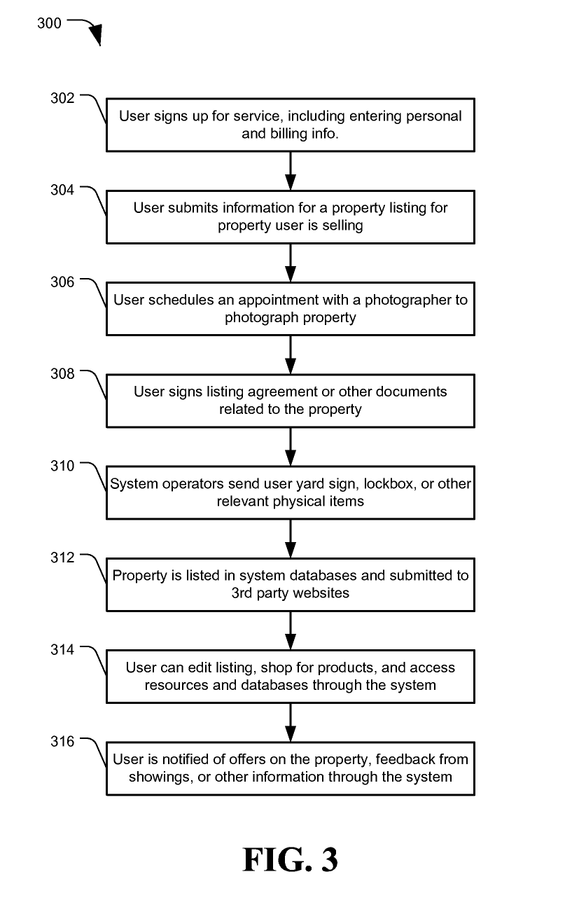

FIG. 3 is a flowchart of an illustrative embodiment of a method of providing real estate services, generally designated 300. More specifically, the example embodiment depicted in FIG. 3 is of a user signing up with the intent to sell property. A user signs up for a real estate service system according to the present disclosure at 302, which may include entering billing information and personal information such a name, mailing address, email address, phone number, and other personal information. Entering billing information may involve selecting a recurring payment plan as described herein, as well as entering credit or debit card number, account routing numbers or other billing information. The user may also select a password and optionally a user name used to log in to the system. The password or user name may be encrypted when stored to the system. The user may also need to agree to terms and conditions associated with use of the service or online user interface.

After signing up for the service, a user may submit information regarding a property the user wishes to sell, at 304. The user may enter an address or location for the property. The user may also enter the type of property and any improvements located thereon, such as a home with details on the number of bedrooms, baths, and square footage. The user may be able to use the system to enter detailed information, such as floor plans, included appliances, bathroom fixtures, flooring details, etc. For land, a user may enter information such as forested, clear, flat or hilly, etc. A user may also specify an asking price for the property, or any other information. Some or all of the information provided by the user may be used to create a property listing that will be added to databases or used for marketing. In some embodiments, the user can browse other sold or listed properties before finalizing the listing data. In some embodiments, a user can save their progress, and finish entering data at a later time.

A user may schedule an appointment for a photographer to photograph the property, at 306. This may be part of the process of submitting property details, or it may be a separate service available through the real estate brokerage system. A user may be able to select a photographer, as well as a time, date, place of meeting, and scope of the photography session. After scheduling, a photographer can photograph the property and upload the photos to the system. The user or photographer may be able to connect the photographs with a property listing, or use the photographs for marketing flyers or other promotional materials.

The user may be required or able to sign listing agreement or other documents related to the property, at 308. The user can have access to the necessary real estate documents and literature via their member portal (each user's personal page available through the system). The user may be able to sign documents with an “electronic signature” (or e-signature) via the user interface of the system, have necessary documents mailed to the user by system operators, or schedule a signing time and location using the user interface.

System operators can send a user “for sale” yard signage, lock boxes, or other relevant physical items, at 310. A lockbox can allow licensed agents and third parties to obtain a key for access to the property. Some or all of these items may be included in the price of signing up with the system, or the user may purchase these products through the user interface separately.

After the relevant property information has been entered and any necessary documentation has been signed, a property listing is generated and entered into system databases, and can be submitted to third-party websites and databases, at 312. For example, on a website associated with the real estate system, each listing can have a dedicated URL (uniform resource locator, or web address) that identifies each property by a unique ID number. This may allow the system to manage all contracts and documents from all parties for the listing. Potential buyers, real estate agents, and other third parties may use the listings to locate potential properties for themselves or their clients. After finding a property listing, potential buyers or buyers' representatives can submit offers or contracts through the system.

The system can allow different levels of access to specific documents based on a specific role for each listing identification number. The seller, the system operators, title companies, buyers and buyers' agents, lenders and other third parties (as discussed before) may have different roles and different levels of access.

A user can edit a listing, shop for products, and access resources and databases through the system, at 314. For example, a seller can have access through the system to search for comparable sold properties. Users can save sold properties to their member portal to help determine an appropriate listing price. Access to sold data is provided through various agreements with local real estate boards and government entities. All vital information on sold properties can be provided to the user. The seller can then edit their property listing with a different asking price based on other sold properties, or update details about the property if the seller makes changes or renovations. The user can also use the system to view tutorials, purchase products, browse forms and documents, or schedule conferences with brokers or other service providers, as some examples.

A user can be notified of offers on a property, feedback from showings, or other information through the system. For example, if a user installs a system interface application on a portable device such as a smart phone, the application can make a notification sound when new data related to a property becomes available to a user. For example, a seller may be notified when property showing feedback is received, or a potential buyer can be notified when a counter-offer from a seller is received. In other embodiments, a user can select to receive a phone call, e-mail, text message, or other notification of updates. When a user is browsing an application-based or internet browser-based user interface for the system, the user may be notified by a pop-up message or graphical indicator on the screen showing that new information has been received.

The embodiment of FIG. 3 is an example embodiment of signing up for and using a user account with a real estate service, and generally is directed toward a user interested in selling property. The steps may be performed in different orders, while some steps may be optional, and other non-listed steps may be included. Potential buyers or third parties may have a different sign-up process requiring different information or providing different available services.

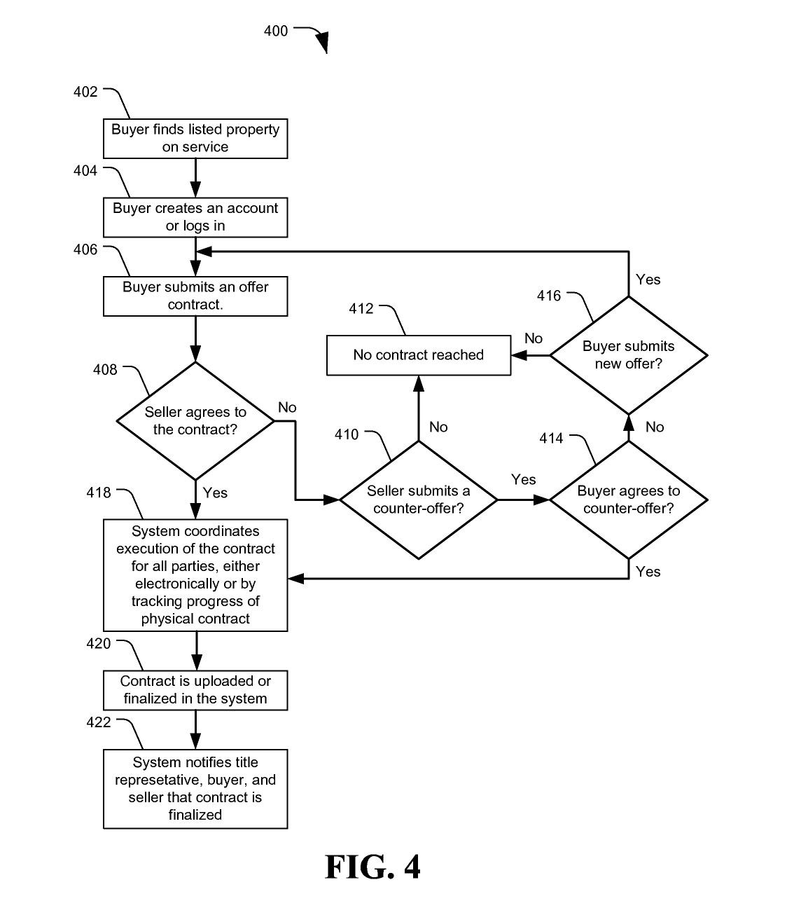

FIG. 4 is a flowchart of another illustrative embodiment of a method of providing real estate services, generally designated 400. A buyer or buyer's agent finds or is directed to a listed property on the real estate service, at 402. The way in which buyers and buyer's agents are directed to the property can vary. For example, the buyer could find it by searching a user interface website of the service. Or, a buyer's agent could be directed to a listing by a system operator. For example, the system could send email notifications of listed properties to agents that have signed up for the emails.

An interested buyer can create an account with the real estate service, or log in to an existing account, at 404. In some embodiments, a buyer may not need an account to browse property listings or submit offers. In some embodiments, creating accounts, browsing listings, or submitting offers may require payment of a one-time or recurring fee.

A buyer can submit an offer contract or propose an offer price on a listed property through the service user interface, at 406. In some embodiments, buyers can browse listings without an account or logging in. After selecting to make an offer, a buyer may then be prompted to log in or create an account, as in 404. A buyer may upload an offer contract and any related documents. In some embodiments, a buyer may be able to fill out data fields through the user interface instead of or in addition to uploading a contract. A buyer may also be able to enter dialogue or comments in addition to a contract or data. In some embodiments, a buyer may also be able to discuss a listing with a seller or seller's representative by instant messaging (IM), text messaging, VOIP, or other communications through the user interface or based on information associated with a listing.

Once submitted, the service can store the contract or offer terms to the system, and send a notification of the offer to the seller as discussed herein. The contract can then be reviewed by the seller, and may also be available for review by system operators or other relevant parties. For example, a title company may be given access to offered contracts on a listing, and may be able to upload documents to one or more parties, such as home owners association (HOA) documents.

By submitting an offer, a unique buyer-to-seller connection can be created, such as with a unique transaction ID. This would allow the buyer, seller, and the service to keep track of the progress of specific transactions between parties. Each seller can have submitted contracts from multiple buyers for a listing, and each buyer can submit offers to multiple sellers on different listings.

A seller can review the terms offered by a buyer and decide whether to agree to the contract, at 408. If the seller agrees to the contract, the real estate system can coordinate execution of the contract and other relevant documents for all parties, at 418. Contract coordination may be handled automatically by software running on the system, overseen by a system operator, or negotiated by the parties through the user interface. Further, execution of the contracts and documents may involve parties electronically signing documents with the system tracking the progress, or execution may involve parties signing physical copies of documents, with the system tracking who has signed the documents and where the documents are currently located, such as by having users input the progress through the user interface.

Buyers, sellers, involved third parties, or a system operator may upload the executed contracts to the system, at 420. In some embodiments, this may involve scanning in a final executed copy of the contract and uploading the scanned document. In some embodiments, such as for digitally signed documents, the documents are marked as “finalized.”

The system can notify the buyer, seller, title representatives, or other involved parties that the contract has been finalized, at 422. For example, notifications may be sent out via email, text message, a visual indicator on the user interface, or by other means that the parties are now under contract.

If a seller does not agree to the offered contract at 408, the seller has the option of submitting a counter-offer or alternate contract, at 410. If the seller chooses not to make a counter-offer, no contract is reached, at 412.

If the seller chooses to submit a counter-offer at 410, the seller can submit a new contract to the buyer via the user interface. The seller may include text to send to the buyer pertaining to the offer. For example, the seller may also direct the buyer to “sold comps,” listings of similar sold properties that the seller saved in the interface, to aid in negotiations. The system can store the counter-offer and send an alert to the buyer of the received counter-offer. The buyer may consider the counter-offer and decide whether to agree to the terms, at 414.

If the buyer agrees to the counter-offer at 414, the method may proceed to contract execution at 418. If the buyer does not agree to the counter-offer at 414, the buyer may choose whether to make a new offer, at 416. If the buyer elects not to submit a new offer, no contract is reached, at 412. If the buyer does choose to submit a new offer, the method can return to the buyer making an offer at 406.

In accordance with various embodiments, the methods described herein may be implemented as one or more software programs running on a computer processor or controller. In accordance with another embodiment, the methods described herein may be implemented as one or more software programs running on a computing device, such as a processing device, a personal computer, server, tablet device, or smart phone. Dedicated hardware implementations including, but not limited to, application specific integrated circuits, programmable logic arrays, and other hardware devices can likewise be constructed to implement the methods described herein. Further, the methods described herein may be implemented as a computer readable storage medium or device including instructions that when executed by a processor, cause the processor to perform such methods, software, functions, or applications.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Additionally, the illustrations are merely representational and may not be drawn to scale. Accordingly, the disclosure and the figures are to be regarded as illustrative and not restrictive.

What is claimed is:

1. A system comprising:
a real estate brokerage system configured to:
aggregate information from multiple computer-based real estate information systems;
provide a graphical user interface (GUI) accessible over a network, the GUI allowing users to access the aggregated information.

2. The system of claim 1, the real estate brokerage system further configured to:
provide users access to the aggregated information over the GUI for a recurring fee.

3. The system of claim 2, further comprising the recurring fee includes a base fee, the base fee allowing access to basic services of the real estate brokerage system.

4. The system of claim 3, further comprising the real estate brokerage system configured to:
provide users access to additional services beyond the basic services for an additional fee beyond the base fee.

5. The system of claim 4, further comprising the additional fee comprises a recurring fee in addition to the base fee.

6. The system of claim 4, further comprising the additional fee comprises a one-time fee in addition to the recurring base fee.

7. The system of claim 6, further comprising the one-time fee assessed retroactively when a user account is closed.

8. The system of claim 2, the recurring fee comprising a flat rate per month.

9. The system of claim 2, the recurring fee comprising a daily base rate.

10. The system of claim 8, the recurring fee comprising the daily base rate is billed to users once per period, a period being a span of time greater than a day.

11. The system of claim 1, the real estate brokerage system further configured to provide real estate services from third parties to users through the GUI.

12. The system of claim 1, the real estate brokerage system further configured to coordinate property sales between property sellers, property buyers and title companies.

13. The system of claim 1, the real estate brokerage system further configured to notify property sellers of offers made by property buyers through the GUI.

14. The system of claim 1, the real estate brokerage system further configured to allow a user to order physical real estate products through the GUI.

15. The system of claim 1, further comprising a user computing device storing instructions that when executed, cause the user computing device to access the real estate brokerage system through the network.

16. The system of claim 1, the real estate brokerage system further configured to send a notice to a user over the network when information is received regarding a property in which the user has expressed an interest.

17. The system of claim 1, wherein the real estate brokerage system further comprises:
one or more processors configured to implement functional aspects of the real estate brokerage system;
an interface to receive requests from other devices wanting to access the real estate brokerage system; and
the real estate brokerage system configured to provide the GUI via the interface in response to the requests.

18. The system of claim 17, wherein the real estate brokerage system further comprises a server including the one or more processors and the interface.

19. A method comprising:
providing real estate brokerage services for a recurring time-based fee including a listing for a property for sale.

20. The method of claim 19 wherein the recurring time-based fee is an amount per day until the listing is either withdrawn or a sale of the property is completed.
